(19) United States
(12) Patent Application Publication
(10) Pub. No.: US 2008/0066850 A1
(43) Pub. Date: Mar. 20, 2008

(54) Method for Producing a Pneumatic Tire for a Vehicle

(75) Inventors: Jorn Seevers, Burgdorf (DE); Jens Winkler, Hannover (DE); Rainer Mauruschat, Garbsen (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 11/865,318

(22) Filed: Oct. 1, 2007

Related U.S. Application Data
(63) Continuation of application No. PCT/EP2006/001085, filed on Feb. 8, 2006.

(30) Foreign Application Priority Data
Apr. 23, 2005 (DE) DE102005018964.4

(51) Int. Cl. B29D 30/10

(52) U.S. Cl. 156/117

(57) ABSTRACT

A pneumatic tire for a vehicle has a casing that extends over the periphery of the tire, a belt that extends radially on the outside of the casing over the entire periphery of the tire and in an axial direction over at least the width of the pneumatic tire. The belt is made of one or several belt plies with rigid supports which are embodied diagonally in the direction of the periphery of the tire and are embedded in a parallel manner in the rubber or plastic material. A bandage extends radially on the outside of the belt over the periphery of the tire. One or several parallel reinforcement supports are wound about the external belt position which is constructed on the construction body in a helical or spiral-shape in the axial direction of the construction body which is oriented, substantially, in the direction of the periphery which is constructed on a pivotable, rotationally-symmetrical construction body which is radial to the outer belt position of the belt in order to produce the bandage. The bandage strip construction material which is made of thread-like reinforcements and/or strip-like bands are guided to the construction body by one or several parallel rigid supports having at least four supply devices which can be moved in relation to the relative position thereof to the construction body and by controlled rotation of the construction body and controlled axial modification of the relative position between the construction body and the supply devices in order to wind on the belt about the belt helically or spirally.

### CROSS-REFERENCE TO RELATED APPLICATIONS

This is a continuing application, under 35 U.S.C. §120, of copending international application PCT/EP2006/001085, filed Feb. 8, 2006, which designated the United States; this application also claims the priority, under 35 U.S.C. §119, of German patent application DE 10 2005 018 964.4, filed Apr. 23, 2005; the prior applications are herewith incorporated by reference in their entirety.

### BACKGROUND OF THE INVENTION

1. Field of the Invention

The invention relates to a method for producing a pneumatic tire for a vehicle, with a casing which extends over the circumference of the pneumatic vehicle tire, with a belt which extends radially outside the casing over the entire circumference of the pneumatic vehicle tire and in the axial direction at least over the tread contact width of the pneumatic vehicle tire. The belt comprises one or more belt plies with reinforcing elements in each case formed obliquely in relation to the circumferential direction of the tire and embedded in parallel in unvulcanized or vulcanized rubber. A bandage extends radially outside a belt ply of the belt over the circumference of the pneumatic vehicle tire, wherein, on the belt ply—in particular the radially outer belt ply—of the belt built up on a rotatable rotationally symmetrical building body, one or more parallel reinforcing elements, aligned substantially in the circumferential direction, is or are wound helically or spirally in the axial direction of the building body around the belt ply—in particular the radially outer belt ply—built up on the building body to produce the bandage.

It is known, for limiting undesired radial dimensional changes of the belt caused by high centrifugal forces acting on the belt, to form around the radially outer belt ply of high-speed tires a bandage ply comprising a rubber strip spirally wound continuously over the entire axial extent of the belt, with reinforcing elements embedded therein in the longitudinal direction of the rubber strip. The resultant identical direction of pitch in which the reinforcing elements run over the entire axial extent of the belt of the tire can lead to concentricity problems. In order to reduce these, it is known, for example from European published patent application EP 0 712 739 A1, to form the bandage symmetrically in relation to the equatorial plane of the tire, in that a first bandage strip is wound on by a first winding head from one edge of the belt and a second bandage strip is wound on by a second winding head from the second edge of the belt toward the equatorial plane. For this purpose, the winding heads are mechanically coupled to each other in their movement on a common spindle in such a way that the winding operation is performed simultaneously in mirror image on both sides of the equatorial plane. A second ply of the bandage is also produced in the same way, by the bandage strips respectively being spirally wound on by the two mechanically intercoupled winding heads respectively on one axial side of the belt in mirror image in relation to the bandage strip of the other side of the belt.

If part of the bandage is to be made of different bandage material, the corresponding winding head must be converted, in that the material is removed from the winding head, the feeding and aligning regions, and replaced by new material. The symmetrical winding with the two winding heads mechanically coupled by means of the common spindle only makes it possible to obtain for the two winding heads a respectively predetermined axial advancement of the winding heads in relation to each other, and consequently a fixed predetermined ratio of the pitches of the bandage regions respectively wound by the two winding heads and a fixed predetermined ratio of the winding density. In some cases, it is desirable to form individual regions of the bandage with a strip width that is different from the bandage material and/or with a bandage material that is different. If a different strip width is chosen, it is first necessary during the building process for the corresponding winding head and the material feed to be converted to provide reliable guidance of the new strip material. In order that the strips can be laid with the same covering density, the spindle must be exchanged during the building process. Since this means that productive manufacture of such tires is only possible with very great additional effort—if at all—the construction of such tires is usually restricted just to the adaptations that can be achieved with little effort with the two winding heads.

Consequently, although the symmetrical winding on by the two winding heads mechanically coupled by means of a common spindle makes it possible to reduce concentricity problems, this entails considerable restrictions in the formation of the bandage with regard to adaptation to the individual requirements of a tire. In spite of the additional effort, formation of the bandage to correspond to individual requirements for the tire is only possible to a greatly restricted extent.

### SUMMARY OF THE INVENTION

It is accordingly an object of the invention to provide a method of producing a pneumatic tire for a vehicle which overcomes the above-mentioned disadvantages of the heretofore-known devices and methods of this general type and which makes it possible to better adapt a pneumatic vehicle tire with a belt and a bandage to the individual requirements of a pneumatic vehicle tire.

With the foregoing and other objects in view there is provided, in accordance with the invention, a method of producing a pneumatic vehicle tire, the pneumatic vehicle tire having a casing that extends over a circumference thereof, a belt that extends radially outside the casing over the entire circumference of the pneumatic vehicle tire and, in an axial direction, at least over a tread contact width of the pneumatic vehicle tire, the belt including one or more belt plies with reinforcing elements in each case formed obliquely to the circumferential direction of the tire and embedded in parallel in unvulcanized or vulcanized rubber material, and and pneumatic vehicle tire further having a bandage that extends radially outside a belt ply of the belt over the circumference of the pneumatic vehicle tire. The novel method comprises the following steps:

providing bandage strip building material formed of reinforcing elements in filament form and/or strip-shaped bands each with one or more parallel reinforcing elements;

guiding the bandage strip building material to a rotatable, rotationally symmetrical building body by at least four feeding devices, wherein the feeding devices are disposed for changing a position thereof relative to the building body in a controlled manner; and

helically or spirally winding the bandage strip building material onto a belt ply of the belt built up on the building body by controlled turning of the building body and controlled axial movement of the relative position between the building body and the feeding devices for the winding operation, to thereby build the bandage of the pneumatic vehicle tire.

In other words, the objects are achieved according to the invention by the method for producing a pneumatic tire for a vehicle, with a casing which extends over the circumference of the pneumatic vehicle tire, with a belt which extends radially outside the casing over the entire circumference of the pneumatic vehicle tire and in the axial direction at least over the tread contact width of the pneumatic vehicle tire, said belt comprising one or more belt plies with reinforcing elements in each case formed obliquely in relation to the circumferential direction of the tire and embedded in parallel in unvulcanized or vulcanized rubber, and with a bandage which extends radially outside a belt ply of the belt over the circumference of the pneumatic vehicle tire, wherein, on the belt ply—in particular the radially outer belt ply—of the belt built up on a rotatable rotationally symmetrical building body, one or more parallel reinforcing elements, aligned substantially in the circumferential direction, is or are wound helically or spirally in the axial direction of the building body around the belt ply—in particular the radially outer belt ply—built up on the building body to produce the bandage, according to the features of claim 1, in which bandage strip building material comprising reinforcing elements in filament form and/or strips in band form with in each case one or more parallel reinforcing elements are guided to the building body by at least four feeding devices, which can be changed in a controlled manner with regard to their relative position in relation to the building body, and are helically or spirally wound around the belt ply—in particular the radially outer belt ply—by controlled turning of the building body and controlled axial changing of the relative position between the building body and the feeding devices for the winding onto the belt ply—in particular the radially outer belt ply—of the belt. This makes it possible to obtain not only symmetrical winding of the bandage with regard to the winding direction but also the use of different materials of the reinforcing elements, different widths of the strips in band form and winding angles in relation to the circumferential direction for different belt regions to correspond to the individual requirements of the tire. Even though good concentricity properties are ensured, individual belt regions can be formed very individually with a bandage individually made to match, and other belt regions with a different bandage individually made to match, without requiring any particular conversion effort. As a result, modifications to match specifically loaded belt regions or to match different tread rubber materials used over the axial extent are individually possible.

Other features which are considered as characteristic for the invention are set forth in the appended claims.

Although the invention is illustrated and described herein as embodied in method for producing a pneumatic tire for a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a partial cross section taken through a pneumatic vehicle tire with a radial casing, belt and bandage;

FIG. 2 is a perspective view of a bandage strip;

FIG. 3 is a perspective view of the spiral or helical winding of a bandage cord or bandage strip on the belt;

FIG. 4 is a schematic view of the tire construction, with four winding heads arranged around a building drum, for producing a belt bandage; and

FIGS. 5A-5G are schematic representations of a belt with a winding bandage to explain different winding patterns.

### DETAILED DESCRIPTION OF THE INVENTION

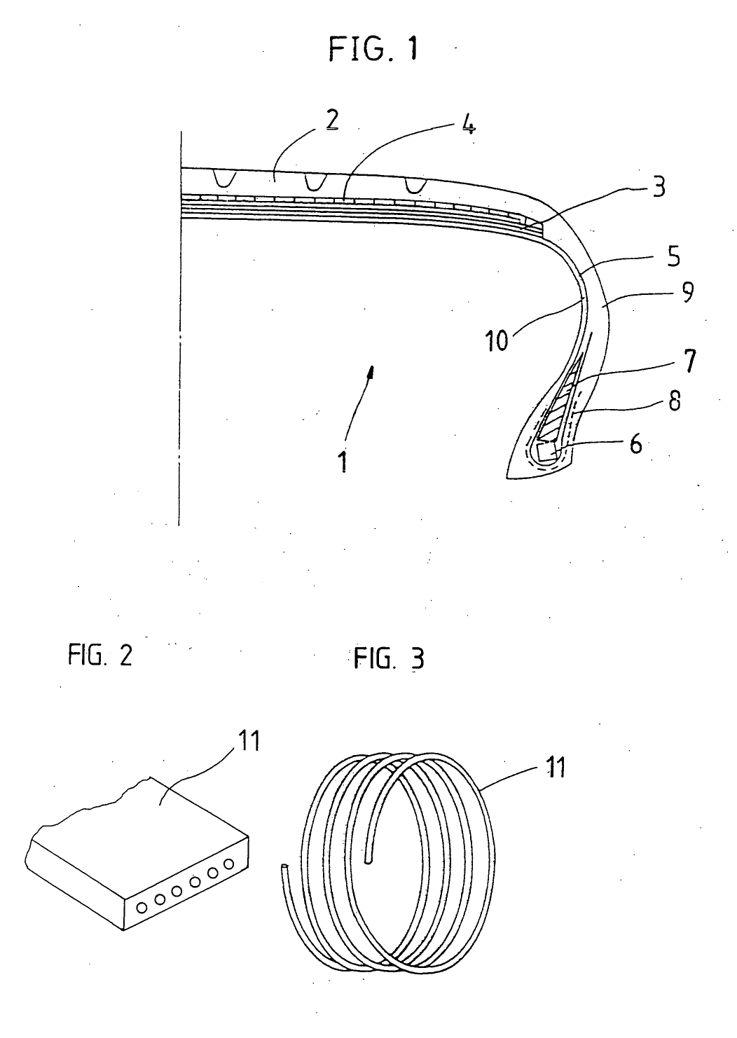

Referring now to the figures of the drawing in detail and first, particularly, to FIG. 1 thereof, a pneumatic vehicle tire is made up of the customary tire components and therefore comprises a profiled tread rubber 2, a belt 3, a belt bandage 4, a radial casing 5 (also referred to as a radial carcass 5), which in the present exemplary embodiment is represented as a single ply and is laid in a conventional way around each bead core 6, a respective bead filler 7 radially outside the bead core 6, bead protection strips 8, a respective sidewall 9, and an airtight inner layer 10.

In the exemplary embodiment, the belt 3 comprises two belt plies with reinforcing elements, in particular of steel cord, running parallel in each ply and embedded in rubber, the reinforcing elements in the two neighboring plies crossing one another. In the tire, the belt plies are arranged in such a way that the steel cords running parallel to one another form an acute angle with the circumferential direction of the tire of the order of magnitude of 15° to 30°, in particular of 20° to 25°. As revealed by FIG. 1 in conjunction with FIGS. 2 and 3, the bandage 4 is formed as a so-called winding bandage, in the case of which a bandage strip 11, which comprises reinforcing elements embedded in a rubber compound and running in the longitudinal direction of the strip 11, are wound around the belt 3. The bandage strip 11 may, for example, be a bandage strip 11 in which, as shown for example by FIG. 2, a number of filaments per cm of strip width are used. In particular, an arrangement of 5 to 12 filaments per cm of strip width, for example of 10 filaments, is customary. The bandage strip 11 itself usually has a width of 5 to 15 mm, for example of 10 mm. The bandage strip 11 may also just be a single reinforcing element embedded in rubber material and formed in the longitudinal direction of the strip.

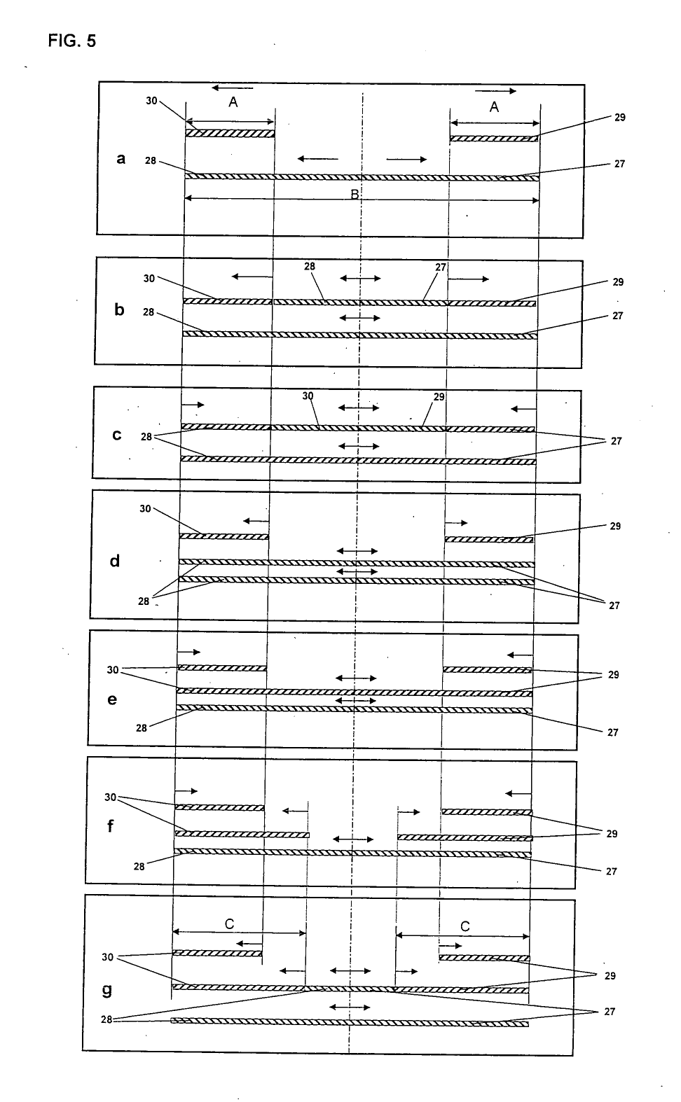

FIG. 3 schematically shows the way in which such a bandage strip 11 is wound spirally about the tire axis. In this case, the bandage strip 11 is wound around the belt in such a way as to produce a winding bandage 4 that in particular covers the belt 3 completely and in which the turns are wound edge to edge. However, it is also possible for a number of plies of winding bandage to be applied to a tire, in particular additional bandage plies may be applied in certain portions at the shoulder regions and—as represented by way of example in FIG. 5A, FIG. 5D, FIG. 5E and FIG. 5G—they should have a width A of at least 15% of the width B of the belt 3 and should cover the borders of the belt 3.

In the finished, vulcanized pneumatic vehicle tire, the bandage strip and the reinforcing element or elements embedded in the bandage strip 11 form a very small angle with the circumferential direction of the tire, when it is in its operating state on the vehicle, of the order of magnitude of 0° to 5°, in particular of 1° to 3°.

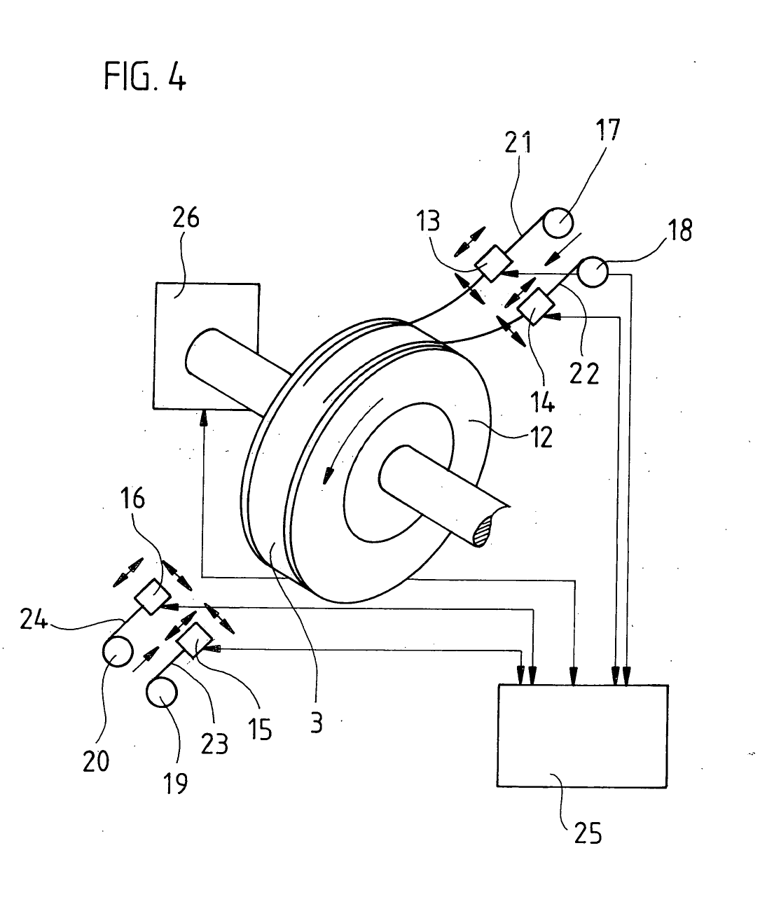

FIG. 4 shows a building drum 12, which is mounted rotatably about its axis in a frame (not represented) and can be turned in a known way about its axis in a controlled manner by means of a drive unit 26 of a known type connected to a control unit 25 of a known type. For building up the bandage strip 11 in various circumferential positions of the building drum, arranged radially outside the radially outer lateral surface of the building drum 12 are four winding heads 13, 14, 15, 16, for laying bandage strip building material onto the radially outer lateral surface of the building drum 12, and they are mounted in such a way that they can in each case be axially displaced in their axial position over the entire width of the building drum and can be radially moved—for example displaced—in their radial position, from a working position designed for covering the lateral surface with bandage material in the region of the radially outer lateral surface of the belt drum 12, radially outward into a rest position, further away from the radially outer lateral surface of the belt drum 12, and in turn back from the rest position into the working position. The winding heads 13, 14, 15, 16 are respectively connected to the control unit 25 and respectively moved individually and independently of one another by means of the control unit from their rest position into the working position for the covering of the belt, in the working position are moved axially parallel to the axis of rotation of the building drum along the lateral surface over the region of the axial extent of the building drum that is respectively to be covered, the axial rate of movement being controlled by means of the control unit in dependence on the rotational speed of the building drum and the desired winding pitch of the bandage strip 11 in relation to the circumferential direction of the belt, and after completion of the winding operation moved again in a controlled manner from their working position at the lateral surface of the building drum radially outward into the rest position.

For supplying bandage strip building material, each winding head 13, 14, 15, 16 is assigned a material source, for example a storage roller 17 or 18 or 19 or 20, respectively, of a known type, which is rotatably mounted in a housing in a known way. So, for example, bandage strip building materials 21, 22, 23, 24 in band form or cord form are stored on the storage drums 17, 18, 19, 20. The bandage strip building material 21 of the storage drum 17 is laid by the winding head 13. The bandage strip building material 22 of the storage drum 18 is laid by the winding head 14. The bandage strip building material 23 of the storage drum 19 is laid by the winding head 15 and the bandage strip building material 24 of the storage roller 20 is laid by the winding head 16. In one configuration, the bandage strip building materials 21, 22, 23 and 24 are respectively formed in the same way. In another configuration, the bandage strip building materials 21, 22 and 23 are respectively formed in the same way. The bandage building material 24 is differently formed. In a further configuration, the bandage strip building materials 21 and 22 are respectively formed in the same way and the bandage strip building materials 23 and 24 are likewise formed in the same way, but differently from the bandage strip building materials 21 and 22. In another configuration, the bandage strip building materials 21 and 22 are respectively formed in the same way and the bandage strip building materials 23 and 24 are respectively formed differently from each other and also differently from the bandage strip building materials 21 and 22. In a further configuration, all four bandage strip building materials 21, 22, 23 and 24 are differently formed.

In a first configuration, the differences between the bandage strip building materials lie in the choice of the modulus of elasticity and/or in the use of different materials of the reinforcing elements. Possible materials of the reinforcing elements are monofilaments and cords of nylon—in particular nylon 6.6—, rayon, polyester, steel or hybrid cords—for example of aramid and nylon—in particular nylon 6.6—or of steel and nylon—in particular nylon 6.6—as well as all other materials known for use as bandage material. So, for example, some of the winding heads 13, 14, 15 and 16 lay bandage strip building material with heat-shrinkable textile reinforcing elements—for example of nylon 6.6—embedded in the bandage strip building material and some others of the winding heads 13, 14, 15 and 16 lay bandage strip building material with hybrid material of nylon 6.6 and aramid of a known type as reinforcing elements embedded in the bandage strip building material. In another configuration, some of the winding heads 13, 14, 15 and 16 lay bandage strip building material with polyester as reinforcing elements embedded in the bandage strip building material and some others of the winding heads 13, 14, 15 and 16 lay bandage strip building material with hybrid material of nylon 6.6 and aramid of a known type as reinforcing elements embedded in the bandage strip building material. In another configuration, some of the winding heads 13, 14, 15 and 16 lay bandage strip building material with nylon 6.6 as reinforcing elements embedded in the bandage building material and some others of the winding heads 13, 14, 15 and 16 lay bandage strip building material with steel cords as reinforcing elements embedded in the bandage strip building material.

In another configuration, the differences of the conveyed bandage strip building material lie in the width of the conveyed bandage strip building material. So, in one configuration, some of the winding heads 13, 14, 15 and 16 lay bandage strip building material of pure rubberized individual cords and some others of the winding heads 13, 14, 15 and 16 lay unvulcanized rubber bands with a number of parallel reinforcing elements embedded in unvulcanized rubber material. In another configuration, some of the winding heads 13, 14, 15 and 16 lay narrow unvulcanized rubber bands with a number of parallel reinforcing elements, for example three, and some others of the winding heads 13, 14, 15 and 16 lay wider unvulcanized rubber bands with, for example, five, eight or ten parallel reinforcing elements.

In another configuration, the differences of the conveyed bandage strip building material lie in the chosen tensile stress that the wound-on bandage strip material has. These stresses are achieved, for example, by the bandage strip building material being laid with different tensile stress. So, in one configuration, some of the winding heads 13, 14, 15 and 16 lay bandage strip building material with a first, constant, lower tensile stress and some others of the winding heads 13, 14, 15 and 16 lay bandage strip building material with a second, constant, higher tensile stress. In another configuration, some of the winding heads 13, 14, 15 and 16 lay bandage strip building material with a first predetermined tensile stress variation, changed over the axial extent of the winding-on region, and some others of the winding heads 13, 14, 15 are 16 lay bandage strip building material with a second predetermined tensile stress variation, changed over the axial extent of the winding-on region. The tensile stress is in this case controlled or regulated in a known way by the control unit 25 by means of a known force regulating mechanism interacting with the respective winding head.

In a further configuration, the winding heads 13, 14, 15 and 16 lay bandage building material that differs both in the material of the reinforcing elements and in the strip width of the bandage building material. In a further configuration, the winding heads 13, 14, 15 and 16 lay bandage building material that differs both in the material of the reinforcing elements and in the tensile stress of the bandage building material. In a further configuration, the winding heads 13, 14, 15 and 16 lay bandage building material that differs both in the tensile stress of the bandage strip building material and in the strip width of the bandage building material. In a further configuration, the winding heads 13, 14, 15 and 16 lay bandage building material that differs both in the material of the reinforcing elements and in the strip width of the bandage building material, and additionally in the tensile stress of the bandage strip building material.

With the building drum 12 driven in a rotating manner and in dependence on the desired winding patterns for the tire to be produced and different bandage regions to be bandaged, the bandage strip 11 is built up on the belt 3 that has been built up on the building drum 12 in a known way and extends over the circumference of the building drum by the winding heads 13, 14, 15, 16 first being moved in a respectively controlled manner into their working position at the radially outer lateral surface of the building drum and the bandage building material 21, 22, 23, 24 respectively to be laid being guided in each case in a known way by the winding heads 13, 14, 15 and 16, respectively, from the storage rollers 17, 18, 19 and 20, respectively, onto the radially outer surface of the belt 3—for example by laying rollers of a known type that are respectively rotatably mounted on the winding heads but are not represented—and by the bandage strip material 21 or 22 or 23 or 24 that is respectively to be laid by the winding head 13, 14, 15 or 16 being laid with the respectively desired winding pitch in relation to the circumferential direction of the belt by the controlled movement of the respective winding head 13, 14, 15 or 16 performed parallel to the drum axis. The rotational movement of the building drum together with the displacing movement of the respective winding head, performed parallel to the drum axis, produce the spiral or helical winding. As soon as the portion of belt that is to be covered by a winding head 13, 14, 15 or 16 is covered with bandage material, the bandage material is cut off in a known way and the winding head 13, 14, 15 or 16 is moved back in a controlled manner from its working position at the building drum into its rest position away from the latter.

In FIGS. 5A to 5G, a number of different exemplary embodiments of winding patterns that can be achieved with such an apparatus are represented by way of example in a cross-sectional representation, which comprises the axis of the building drum. The arrows depicted respectively indicate the direction of axial displacement of a winding head and consequently the winding direction with respect to the building drum during the winding.

FIGS. 5A to 5G thereby respectively show winding patterns with different winding regions 27, 28, 29 and 30, the winding region 27 being covered with bandage building material 21 by the winding head 14, the winding region 28 being covered with bandage building material 22 by the winding head 13, the winding region 29 being covered with bandage building material 23 by the winding head 15 and the winding region 30 being covered with bandage building material 24 by the winding head 16. In FIGS. 5A to 5G, a winding pattern symmetrical to the axial center of the belt width is respectively represented by way of example, a pattern in which the winding direction chosen on one axial side of the center of the belt width is respectively chosen to be symmetrical to the winding direction of the other axial side.

FIG. 5A shows a first winding pattern, with four different winding regions 27, 28, 39 and 30, the winding region 27 being covered with bandage building material 21 by the winding head 14, the winding region 28 being covered with bandage building material 22 by the winding head 13, the winding region 29 being covered with bandage building material 23 by the winding head 15 and the winding region 30 being covered with bandage building material 24 by the winding head 16. The winding heads 13 and 14 thereby cover winding regions 27, 28 of a radially inner, first bandage ply in each case with an axial direction of displacement, and consequently winding direction, during the winding from the center of the axial width of extent B of the belt 3 axially outward toward the belt edge. The winding heads 15 and 16 form with their winding regions 29 and 30 just border strips, covering over the belt edges, of a radially outer second bandage ply, likewise wound from axially inward to axially outward, with an axial width of extent A of the border strips, where the width of extent is chosen such that A≦(B/2).

In FIG. 5B, the winding heads 13 and 14 cover the belt 3 with an additional, radially outer second bandage ply on the first, radially inner bandage ply first formed by them, which second bandage ply respectively extends just in the axial central region between the two belt covering edge regions 29 and 30 formed by the winding heads 15 and 16. In this configuration, too, all four winding heads 13, 14, 15, 16 respectively wind from axially inward to axially outward in the direction of the belt edge.

In the configuration of FIG. 5C, after winding a first radially inner ply, the two winding heads 13 and 14 are axially displaced respectively from the center axially outward toward the belt edge and they respectively cover the two axially outer regions of the belt 3 with a second, radially outer ply, formed on this first ply, to cover the belt edges, the two winding heads 13 and 14 being displaced for this purpose from axially outward to axially inward. The axial region of extent that is located between the two regions 27 and 28 of the second ply wound by the winding heads 13 and 14 is wound by the winding heads 15 and 16 over the winding regions 29 and 30, with axial displacement of the winding heads from axially inward in the direction of the belt edges.

The winding pattern of FIG. 5D corresponds largely to the winding pattern of FIG. 5A, but, after winding on of a first ply by the winding heads 13 and 14, a second ply is wound on in the same way by these two winding heads 13 and 14. Only on the second ply is the belt edge covering strip wound on by the winding heads 15 and 16, in a third ply, over an axial region of extent A, to reinforce the belt edge region.

FIG. 5E illustrates a configuration of a winding pattern in which the first ply is formed as in the configuration of FIG. 5A by the winding heads 13 and 14 and in which a second ply, which respectively extends likewise from the axial center of the belt axially outward to the belt edge border, is wound onto this first ply by the winding heads 15 and 16, the winding heads 15 and 16 then winding onto this second ply in the belt edge region a further covering strip, in a third ply, over an axial region of extent A respectively extending from axially outward in the direction of axially inward.

FIG. 5F presents a winding pattern produced as in the configuration of FIG. 5E, the winding heads 15 and 16 beginning to wind the second ply not from the axial center of the axial belt width B, but from an axial distance from the axial center of the belt width B, axially outward to the respective belt edge border over an axial region of extent C, where A<C<(B/2). In this way, a finely graduated reinforcing pattern is produced over the axial belt width B.

FIG. 5G shows a winding pattern similar to the winding pattern of FIG. 5F, but with the axial central region that remains in the second ply between the winding regions 29 and 30 covered by the winding heads 15 and 16 being wound by the winding heads 13 and 14, from the axial center of the belt width B axially outward to the winding regions 29, 30.

The third ply may thereby be wound in the same way as the third ply of FIG. 5B from axially outward to axially inward or—as represented in FIG. 5G—as an alternative to this from axially inward to axially outward to the belt edges.

In a further configuration—not represented—further additional winding heads—for example two further winding heads—can in the same way be moved in a controlled manner and can be arranged in the region of the building drum in such a way that they can be provided with belt bandage strip material, as illustrated above in connection with the winding heads 15, 16, 17 and 18. In this way it is possible, for example, to produce the winding pattern of FIG. 5G by the third ply of the bandage strip being laid by the two further winding heads. In this case, for example, the winding heads 13, 14 would lay a first bandage strip material with a great strip width of 10 mm, with 10 parallel reinforcing elements embedded in the rubber material, the winding heads 15, 16 would lay a second strip building material with a smaller strip width of, for example, 5 mm, and with just five parallel reinforcing elements embedded in the rubber material, and the two additional winding heads would lay a third strip building material, for example of rubberized individual wire.

It is similarly conceivable if need be to wind bandage building material onto a belt by eight or twelve winding heads.

The building drum is represented in FIG. 4 as a building drum with a cylindrical lateral surface. It is similarly possible to form the building drum with a contoured lateral surface. So it is possible, for example, to form the building drum in its cross section formed by the drum axis with a crowned, convex or if need be concave radial outer contour on its radially outer lateral surface. Instead of the building drum, it is similarly possible to use a toroidal building body of a known type for building up the belt and the bandage.

1. A method of producing a pneumatic vehicle tire, the pneumatic vehicle tire having a casing that extends over a circumference thereof, a belt that extends radially outside the casing over the entire circumference of the pneumatic vehicle tire and, in an axial direction, at least over a tread contact width of the pneumatic vehicle tire, the belt including one or more belt plies with reinforcing elements in each case formed obliquely to the circumferential direction of the tire and embedded in parallel in unvulcanized or vulcanized rubber material, and and pneumatic vehicle tire further having a bandage that extends radially outside a belt ply of the belt over the circumference of the pneumatic vehicle tire, the method which comprises:
providing bandage strip building material formed of reinforcing elements in filament form and/or strip-shaped bands each with one or more parallel reinforcing elements;
guiding the bandage strip building material to a rotatable, rotationally symmetrical building body by at least four feeding devices, wherein the feeding devices are disposed for changing a position thereof relative to the building body in a controlled manner; and
helically or spirally winding the bandage strip building material onto a belt ply of the belt built up on the building body by controlled turning of the building body and controlled axial movement of the relative position between the building body and the feeding devices for the winding operation, to thereby build the bandage of the pneumatic vehicle tire.

2. The method according to claim 1, which comprises winding the bandage strip building material onto a radially outer belt ply of the belt.

3. The method according to claim 1, wherein the bandage strip building material comprises reinforcing elements in filament form and/or strips in band form, and the winding step comprises winding in each case one or more parallel reinforcing elements helically or spirally onto a belt built up on a building drum, around the belt.

4. The method according to claim 1, which comprises guiding the bandage strip building material comprises reinforcing elements in filament form and/or strips in band form with in each case one or more parallel reinforcing elements to the building body by at least four winding heads, the relative position of which is movable in a controlled fashion relative to the building body, and helically or spirally winding around the belt by controlled turning of the building body and controlled axial movement of the relative position between the building body and the feeding devices for winding onto the belt.

5. The method according to claim 4, which comprises connecting each winding head, at least during the winding, to a separate material storage device, and feeding the bandage strip building material from the respective material storage device to the respective winding head.

6. The method according to claim 1, which comprises feeding, with the feeding devices, at least two different bandage strip building materials formed of reinforcing elements in filament form and/or strips in band form with in each case one or more parallel reinforcing elements.

7. The method according to claim 6, which comprises feeding, with the at least four feeding devices, at least two different bandage strip building materials formed of reinforcing elements in filament form and/or strips in band form with in each case one or more parallel reinforcing elements, wherein the different bandage strip building materials are different with regard to a modulus of elasticity of the reinforcing elements thereof.

8. The method according to claim 6, which comprises feeding, with the at least four feeding devices, at least two different bandage strip building materials formed of reinforcing elements in filament form and/or strips in band form with in each case one or more parallel reinforcing elements, wherein the different bandage strip building materials are different with regard to a chosen material of the reinforcing elements.

9. The method according to claim 6, which comprises feeding, with the at least four feeding devices, at least two different bandage strip building materials formed of reinforcing elements in filament form and/or strips in band form with in each case one or more parallel reinforcing elements, wherein the different bandage strip building materials are different with regard to a width of the bandage strip building materials.

10. The method according to claim 6, which comprises feeding, with the at least four feeding devices, at least two different bandage strip building materials formed of reinforcing elements in filament form and/or strips in band form with in each case one or more parallel reinforcing elements, wherein the different bandage strip building materials are different with regard to a tensile stress placed thereon during the winding operation.
